(19) United States
(12) Patent Application Publication
(10) Pub. No.: US 2008/0299324 A1
(43) Pub. Date: Dec. 4, 2008

(54) Modified printable surfaces

(76) Inventors: Andrew S. Naisby, Kennett Square, PA (US); Sebastien Villeneuve, Huningue (FR); Stephan Ilg, Giebenach (CH); Amalia Di Matteo, Calderara di Reno (BO) (IT)

Correspondence Address: JoAnn Villamizar;Ciba Corporation/Patent Department, 540 White Plains Road, P.O. Box 2005, Tarrytown, NY, 10591, US

(21) Appl. No.: 12/154,784

(22) Filed: May 27, 2008

Related U.S. Application Data
(60) Provisional application No. 60/932,725, filed on Jun. 1, 2007.

(51) Int. Cl. C08J 7/18; C08F 4/00; C08F 4/32; C08K 5/42; B32B 27/38; B32B 27/00

(52) U.S. Cl. 427/504; 427/511; 522/65; 522/68; 522/6; 522/79; 428/413; 428/500

(57) ABSTRACT

Printed images with excellent image quality, adhesion and durability are prepared by applying an ink to a printable surface which contains one or more components containing reactive groups followed by exposing the surface with the applied ink to ultra-violet light, high intensity visible light, or electron beam radiation. The surfaces of typically non-adherent substrates, such as polyolefins and PET are rendered adherent using this method without plasma, corona or flame treatment. The reactive groups include ethylenically unsaturated groups such as vinyl, vinyl ether, allyl, methacrylate, acrylate etc, epoxides, hydroxyl, amines, acidic groups, basic groups and free radical generating groups. The images exhibit good resolution, edge acuity and permanence.

This application claims benefit under 35 USC 119(e) of U.S. provisional application No. 60/932,725 filed Jun. 1, 2007.

A durable printed image with excellent image quality and adhesion is prepared by applying an ink to a printable surface, which surface contains one or more reactable components capable of undergoing reaction upon exposure to ultra-violet light, high intensity visible light or electron beam radiation, and then exposing the surface with the applied ink to ultra-violet light, high intensity visible light, or electron beam radiation. The reactive groups include ethylenically unsaturated groups such as vinyl, vinyl ether, allyl, methacrylate, acrylate etc, epoxides, hydroxyl, amines, acidic groups, basic groups and free radical generating groups. The images exhibit good resolution, edge acuity and permanence.

### BACKGROUND

Ink jet printing is emerging as the digital printing method of choice due to good resolution, flexibility, speed, and affordability. With the continued introduction of new digital cameras, computer systems and software, consumers and businesses are able to use digital imaging and ink-jet printing systems to create a wide variety of media products in their own homes and offices. For example, small format products include greeting cards, posters, calendars, newsletters, fliers, window decals, business cards, newsletters, brochures and the like. Companies can also create large indoor and outdoor advertising displays such as banners and other graphic art materials for business presentations.

A fast-growing market for ink-jet printing is in the flexible packaging sector. Digital printing in general is used in this industry to print variable data such as bar codes and expiration dates and the “print-on-demand” aspect of digital printing lends itself well to this type of application. Historically, the limitation of slow printing speeds, especially ink-jet printing speeds, hindered ink-jet as the printing method of choice for printing the entire packaging graphic. The printing speed limitation is being addresses and many ink-jet hardware manufacturers now boast printing speeds equivalent to conventional printing methods. Consequently, the through-put limitation then becomes the ability to dry an ink-jet ink at fast printing speeds, U.V. curing and the use of U.V. curable inks can provide a solution to this limitation, yet challenges remain.

Transparency, ink adhesion, water and chemical resistance are all important requirements for printed materials used to create flexible packaging. However, Ink jet inks do not uniformly adhere to all substrates and image permanence and durability remains a shortcoming in certain applications. Systems designed for improved water resistance may not meet transparency requirements. Given the complex nature of an ink jet printing system, technical solutions for one problem, such as poor adhesion, may cause deterioration in other important parameters such as dry time or sharpness of image. The present invention describes a further enhancement of radiation curing technology using ink and matching media designs which addresses all of the afore mentioned requirements.

The aforementioned ultraviolet (UV) curable inks continue to find growing use in ink-jet printing. These inks contain reactive components such as reactable monomers, oligomers, polymers, reactable diluents, photo-initiators and the like, as in, for example, U.S. Pat. Nos. 7,037,952 and 6,737,122, the disclosures of which are incorporated in their entirety by reference. Hardware and consumables that print and cure UV inks are commercially available. However, UV curable inks have problems of their own such as difficulty in attaining proper ink viscosity for stable printer discharge and blurring which can occur during the time period between printing and treatment with ultraviolet light.

Ink jet printers operate by ejecting controlled patterns of closely spaced and sometimes overlapping ink droplets through very fine nozzles in a printer onto a receiving substrate. The quality of the image is partly dependent on the composition of the ink-jet recording medium, such as ink receiving layers frequently applied as coatings in multilayered ink jet media. Inks used in ink jet printers are typically water-based or solvent-based inks that generally contain about 90% organic and/or aqueous solvents. Water-based inks typically require porous substrates or substrates with special coatings that absorb water.

In order to achieve good image quality during ink jet printing the printed ink drops must spread to within an acceptable range in order to provide complete solid fill of the image. Overly rapid uptake of the water or carrier solvent in an ink by the receptive layer tends to result in ink drops not spreading enough leaving unfilled background areas that contribute to reduced color density and banding defects (i.e. gaps between the rows of ink drops). On the other hand, overly slow uptake of water or carrier solvent tends to result in ink drops spreading too much resulting in loss of resolution, poor edge acuity, and inter-color bleed occurs in the case of multi-color graphics.

From an ink formulator's perspective obtaining sufficient reactivity in a UV curable ink that has low enough viscosity to be jetted successfully through an ink-jet print head is a challenge. For example, many conventional film formers which may be used in UV cure inks have significantly higher viscosity than the approximately 10 cps found in many drop on demand ink jet formulations. As a result, U.V. curable ink-jet inks typically comprise monomers or diluents that have low reactivity but are added to reduce viscosity. Binder polymers which are frequently present in these inks are also typically low in molecular weight for the sake of maintaining low ink viscosity. However, the low molecular weight and/or low reactivity of the monomers, oligomers, polymers etc present in a typical low viscosity UV curable ink may result in an intrinsically poor chemical and physical resistance of the cured image.

In many cases obtaining a crisp image often requires that the ink be exposed to UV radiation immediately after jetting to prevent the ink from spreading and causing a visual deformation of the print.

Furthermore, environmental concerns often make water based inks and materials more desirable than solvent based formulations. Unfortunately, many of the reactive monomers and oligomers useful in UV cured inks are not water soluble. Also many photo initiators useful in UV cured inks are not water soluble or easily dispersed in water.

Although there is much focus in the development of UV curable ink and the hardware associated with printing and curing of such inks, there has been little on the development of specially treated receptive media and what this might bring to the technology.

Both the quality and permanence of an ink-jet printed image depends in part on the ink, in part on the media upon which the ink is printed, and on interactions between the two. For example, copending U.S. patent application Ser. No. 10/493,338, filed Oct. 20, 2004; Ser. No. 10/499,854 filed Jun. 21, 2004; Ser. No. 10/499,855 filed Jun. 21, 2004; Ser. No. 10/887,197 filed Jul. 8, 2004 and Ser. No. 10/890,449 filed Jul. 13, 200, the disclosures of which are incorporated herein in their entirety by reference, disclose multi-component co-polymers that are used in ink receiving layers to improve the quality, increase the dry time and improve the water fastness and weatherability of the ink jet image.

US Published Pat App. No. 20060204686 discloses multi layered, thermally fusible, reactive inkjet recording media comprising a top layer comprising thermoplastic polymer particles having reactive functional groups and a lower cross-linker-containing layer comprising a polyfunctional compound having complementary reactive functionalities that can crosslink the reactive functionalities on the thermoplastic polymer particles when the layer is fused.

Plasma treatment, corona treatment or flame treatment have been employed in processes to improve the printability of certain substrates. For example, US Published Pat App. No 20060257681, incorporated herein by reference, discloses a process for improving the printability of a substrate by subjecting it to a plasma treatment (low pressure and/or normal pressure plasmas), corona treatment or flame treatment prior to applying a coating which is cured. The coatings, which are suitable for printing and are capable of containing reactive components, adhere to the substrate in large part due to the pretreatment.

### SUMMARY OF THE INVENTION

It has been found that one can incorporate into the surface of an ink receiving substrate reactable components that are typically found in UV curable inks, apply an ink to the substrate and then cure substrate with the ink by exposure to UV light, high intensity visible light or electron beam radiation to obtain a high quality, permanent image without prior plasma treatment (low pressure and/or normal pressure plasmas), corona treatment or flame treatment of any of the components that make up the article which comprises the printed image. Incorporating reactable components into the surface allows for greater flexibility in ink formulation. This process can therefore provide a radiation cured image with advantages associated with using UV curable inks while providing greater control over the printing process and less image distortion or blurring frequently encountered with UV cured inks. Thus a printed image is obtained with excellent resolution, edge acuity, adhesion, scratch and mar resistance, durability and longevity.

Provided therefore is a method of producing a printed image which method comprises

a. preparing a printable surface comprising a polymer and one or more reactable components capable of undergoing reaction upon exposure to ultra-violet light, high intensity visible light or electron beam irradiation
b. applying an ink to said surface and then
c. exposing the surface with applied ink to ultra-violet light, high intensity visible light or electron beam radiation to initiate reaction of the one or more reactable components of the surface,
which process excludes plasma treatment, corona treatment or flame treatment, prior to exposing the surface with applied ink to ultra-violet light, high intensity visible light or electron beam radiation, of any component comprised by an article which comprises the printed image.

The process can be used to prepare any image that can be produced by a printing process including text, symbols, geometric figures, charts, designs, pictures, random markings even a complete covering of the printed surface by the ink. The are no limitations on the kind of image produced.

The printable surface is the surface of a polymer containing material, for example a synthetic polymer, which has been formulated or modified to incorporate within it the reactable components. The polymeric material may be part of a coating applied to a substrate.

The ink can be almost any ink formulation and may likewise contain one or more components which are capable of undergoing reaction upon exposure to ultra-violet light, high intensity visible light or electron beam irradiation.

The ink used in preparing the image may be applied by any known means. In a particular embodiment of the invention, the ink is applied using an ink jet process.

Also provided is printing media comprising a printable surface comprising a polymer and one or more reactable components capable of undergoing reaction upon exposure to ultra-violet light, high intensity visible light or electron beam wherein each component of the printing media is free of any plasma treatment, corona treatment or flame treatment.

### DETAILED DESCRIPTION OF THE INVENTION

The reactable components contained in the printable surface are, for example, compounds containing one or more reactable groups selected from ethylenically unsaturated groups such as vinyl, vinyl ether, allyl, methacrylate, acrylate, methacrylamide or acrylamide groups, epoxides, hydroxyl, amines, acidic groups, basic groups, latent acids, latent bases and free radical generating groups.

For example, the reactable components are monomers, oligomers, polymers, prepolymers, polymerization initiators, catalysts and the like which comprise one or more of the aforementioned reactable groups.

The polymerization initiators are for example photo polymerization initiators, more commonly called photo initiators. These are compounds which under exposure to light generate species which are capable of initiating chemical reactions with other chemical species. The photo initiators may initiate a reaction sequence without being incorporated, either in part or in total, into the final reaction product, or they may become incorporated, in part or in total, into the final reaction product.

In one embodiment, the reactable components contained in the printable surface prior to application of the ink react upon exposure to light, for example UV or visible light, for example UV light, or electron beam radiation with compounds formulated into the ink. For example, reactable monomers or oligomers incorporated into the printable surface prior to printing may react with monomers or oligomers in the ink formulation to form a polymer; a reactable polymer formulated into the surface may react with a crosslinking agent in the ink providing a crosslinked polymer, etc.

Obviously, either the ink or the surface may be formulated to contain a photo initiator.

Water based inks are often more desirable than solvent based inks for environmental reasons. Many photo initiators useful in UV cured inks are neither water soluble nor easily dispersed in water. In one embodiment of the invention, a photo initiator is incorporated into a printable surface prior to application of the ink. In another embodiment, a water based ink is applied to the printable surface into which a photo initiator has been incorporated. In another embodiment, a water based ink which does not contain a photo initiator, is applied to the printable surface into which a photo initiator has been incorporated.

Encapsulated photo initiators, which in many circumstances offer processing advantages, may be used in the present invention, for example, as part of the modified surface, but as referred to above, such photo initiators may be a part of the ink which is applied to the inventive surface.

Aromatic dicarbonyl photo initiators such as phenylglyoxalic esters are useful in this invention. These are known, non-volatile compounds disclosed, for example, in WO 06/067061 and U.S. Pat. No. 6,048,660, the disclosure of which is incorporated in its entirety by reference. Phenylglyoxalic photo initiators and diacrylates or polyacrylates based on polyethylene glycol diacrylate ester are particularly useful in this invention for example tridecylethyleneglycol-bis-phenylglyovalate.

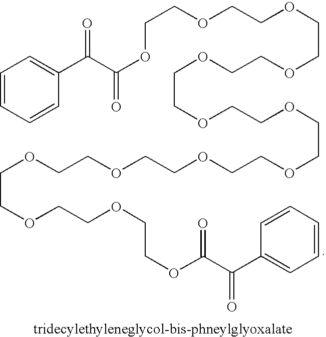

Water soluble and water dispersible photo-active compounds can be formulated into the print media of the invention along with appropriate polymers and oligomers to allow a water-based ink to dry on the printable surface, if desired, before final curing by exposure to UV light, high intensity white light or electron beam irradiation, thus alleviating many of the disadvantages known in the art associated with printing U.V. curable water-based inks. Hence better image quality, little to no image smear, better edge acuity and water and solvent resistance is readily obtained.

While the combination of printable surface and applied ink which is exposed to ultra-violet light, high intensity visible light or electron beam radiation of the present invention may in many ways resemble in composition that which is created by applying a fully formulated UV curable ink onto a known printable surface, the instant process provides greater flexibility which can lead to higher image quality.

Reactable oligomers and polymers with higher viscosity can be employed because they are incorporated into the print media and need not be introduced via a low viscosity ink. Also, materials not compatible with the printing process for other reasons such as poor dispersability or incompatibility with the print head or print head temperatures can be incorporated directly into the printable substrate before printing occurs.

Greater flexibility in ink formulation is also provided by incorporating into the printable surface components that are traditionally found in UV curable inks. For example, the amount of diluents added to the ink to control viscosity can be reduced or eliminated, and therefore cease to be problematic for efficient radiation curing, because higher viscosity materials, such as oligomers and polymers, can formulated into the print receptive surface instead of the ink. Not only can a more reactable system be created, but an ink can be used which is less prone to smear or other image distortion.

In another embodiment of the invention, reactable components contained in the printable surface prior to application of the ink react, after application of the ink and upon exposure to UV or visible light, for example UV light, or electron beam radiation, with other reactable components also comprised by the printable surface prior to application of the ink. For example, polymerization or crosslinking of reactable monomers, oligomers or polymers may provide a polymeric system which entrains components of the ink or otherwise modifies the post printed surface to improve the durability, gloss or other feature of the image. Better image quality can be obtained because the ink no longer needs to contain components that can lead to image smear or poor edge acuity. Again, the present method makes it possible for the ink to dry on the printable surface before final curing by exposure to UV light, high intensity visible light or electron beam radiation.

Either fully formulated UV curable inks, for example commercial UV curable inks, or inks that are non-UV curable, for example those printed from standard ink jet printers such as home and office printers etc, can be used as the ink in the present invention depending on the printable surface formulation. In many instances, the ink will comprise some, but not necessarily all components needed for photo or electron beam curing with the rest of the needed components formulated into the surface of the print media.

While paper or coated paper is a common substrate for printing, almost any substrate can comprise a printable surface and be used as printing media. For example, plastic articles are printed on to make a variety of products, common examples include polymers such as vinyl and polyester sheets used in printing banners or presentation materials, plastic labels, decals, markings printed onto polycarbonate audio or video discs, the polyurethane coating layer of a golf ball etc. Metallic materials can be printed on, particularly with the aid of primer surfaces or adhesion promoters.

The printable surface of the invention can therefore be correctly referred to as the surface of a printing medium with the “printable surface” being that portion of the medium which is directly exposed to the ink. That is the outermost portion of a substrate or article onto which the ink is applied or into which the ink penetrates. For example, the surface may be comprised by the outermost layer of a multilayered article, such as a coating or film which is applied to a substrate, the surface may be comprised by a free standing film, the surface may also be comprised by a thicker polymeric article, for example, a thicker polymeric article wherein the outermost portions have been modified to include the reactable components of the invention.

The printable surface which receives the ink in this invention is comprised by a formulation comprising polymers. The printing medium may therefore be part of a multilayered substrate wherein one of the layers is a polymer formulation incorporating the reactable components of printable surface of the invention, or the medium may be a plastic article into which the reactable components of the invention are incorporated.

A variety of complimentary methods for preparing the printable surface of the invention are available.

A formulation comprising the polymers of the ink receiving layer and the reactable components of the inventive printable surface may be prepared and used as a coating layer. For example, water soluble or water dispersible coatings containing any of a variety of polymers and blends of polymers are used as ink receiving layers for many ink jet media. The reactable components of the inventive polymer surface can be incorporated into such a coating and applied to a substrate via any of the known methods such as slot die, gravure, Meyer bar, spin coating, draw downs, spraying, dipping, etc.

When the reactable components of the printable surface are incorporated as part of a coating layer, the layer is dried or otherwise cured before application of the ink. UV radiation has also been used to cure ink receptive coating prior to being printed on as in U.S. Pat. Nos. 7,166,332 and 6,562,441. The curing of the coating layer prior to printing is not to be confused with the curing of the image which occurs after ink application which is part of the present method providing for superior durability of the final print.

The reactable components may also be introduced to the printable surface as a part of a formulation which is applied to the ink receiving layer after the layer is formed. For example, a formulation containing the receiving polymers can be coated onto a substrate and then a formulation comprising the reactable components can be applied to the coating. Given the variety of coating techniques available, the formulation comprising the reactable components can be applied either to a cured polymeric coating, or an uncured coating.

Application of the formulation comprising the reactable components to an already dried or cured coating would require the reactable components to penetrate at least somewhat into the surface of the coating. A similar process can be employed to allow the reactable components to imbibe into the surface of a stand alone polymeric film, fabric, molded article or other plastic substrate. Any volatile solvents used in such a process would typically be removed prior to printing.

Similarly, a formulation comprising the polymers of the ink receiving layer and the reactable components of the inventive printable surface may be prepared as a stand alone film which is then printed upon, as in, for example, the preparation of a decal.

The polymer formulation may be a thermoplastic polymer comprising the reactable components of the invention which is thermally processed by traditional methods to prepare a film, a thicker molded article or fibers such as used in fabrics and carpets which may then be printed on according to the invention.

The printable surface of the invention may also be prepared as thermally extruded layer as found in, for example, co-extrusion or extrusion coating applications.

When printing onto a printable surface containing the reactable components according to the present invention, no additional treatments, such as corona treatments or other surface activation treatments are required.

The present invention is particularly useful in preparing ink jet printed images on multilayered ink jet media wherein the reactable components of the printable surface are incorporated into a coating formulation comprising ink receiving polymers which is applied to a substrate and dried or otherwise cured prior to printing and exposure to UV light, high intensity visible light or electron beam irradiation.

When the printable surface is prepared by applying a coating to a substrate, polymers commonly found in ink jet receiving layers are of particular interest, for example polyacrylates, polyacrylamides, PVP, polyesters, polyurethanes, polyamides, polyvinyl alcohols, for example water soluble or water dispersible polymers such as water soluble or water dispersible polyacrylates, polyacrylamides, PVP, polyurethanes, polyamides, gelatin, hydroxypropyl cellulose and polyvinyl alcohols. Ionic polymers, such as cationic, anionic or zwitterionic polymers of the preceding classes are also of particular interest, such as polymeric high molecular weight ammonium salts or cationic or zwitterionic polyacrylates or polyacrylamides. Polymer blends are frequently encountered as print media and may be found in the printable surface of the present invention.

For example, in one embodiment, the polymer of the printable surface is a copolymer containing acrylate and/or acrylamide monomers. When used herein, acrylate alone includes methacrylate etc, acrylamide alone includes methacrylamide etc; both terms, e.g., acrylate and methacrylate, may appear together for emphasis or added specificity.

Excellent results have been achieved, for example, when the printable surface is prepared by applying a coating to a substrate containing the polymers of U.S. patent application Ser. Nos. 10/493,338; 10/499,854; 10/499,855; 10/887,197 and 10/890,449, as at least part of the polymer component of the printable surface. These polymers are valuable in the production of multilayered ink jet media such as coated ink jet papers, and coated polyester, polyolefin and vinyl sheets.

For example the polymer of the material comprising the printable surface comprises zwitterionic, cationic or anionic acrylate and/or acrylamide monomers and nonionic acrylate and/or acrylamide monomers. The polymer may comprise other monomers including crosslinkers and associative monomers.

Common nonionic monomers of these polymers include acrylamide, methacrylamide, N-methylacrylamide, N,N-dimethyl(meth)acrylamide, N-isopropyl(meth)acrylamide, N-(2-hydroxypropyl)methacrylamide, N-methylolacrylamide, N-vinylformamide, N-vinylacetamide, N-vinyl-N-methylacetamide, poly(ethylene glycol)(meth)acrylate, poly(ethylene glycol)monomethyl ether mono(meth)acrylate, N-vinyl-2-pyrrolidone, glycerol mono((meth)acrylate), 2-hydroxyethyl(meth)acrylate, vinyl methylsulfone, vinyl acetate, diacetone acrylamide, acrylate and methacrylate esters and acids and associative monomers.

Common zwittwerionic monomers include N,N-dimethyl-N-acryloyloxyethyl-N-(3-sulfopropyl)-ammonium betaine, N,N-dimethyl-N-acrylamidopropyl-N-(2-carboxymethyl)-ammonium betaine, N,N-dimethyl-N-methacryloyloxyethyl-N-(3-sulfopropyl)-ammonium betaine, N,N-dimethyl-N-methacrylamidopropyl-N-(3-sulfopropyl)-ammonium betaine, 2-(methylthio)ethyl methacryloyl-S-(sulfopropyl)-sulfonium betaine, 2-[(2-acryloylethyl)dimethylammonio]ethyl 2-methyl phosphate, 2-(acryloyloxyethyl)-2′-(trimethylammonium)ethyl phosphate and [(2-acryloylethyl)dimethylammonio]methyl phosphonic acid.

Common anionic and cationic monomers are well known and include aminoalkyl acrylates and acrylamides, derivatives of vinyl alcohols, vinylamines, polyamines, carboxylate containing monomers etc, for example, quaternary ammoniumalkyl acrylates and methacrylates.

For example, the polymer may be a co-polymer comprised of methyl methacrylate and dimethylaminoethyl methacrylate, or methyl methacrylate, dimethylaminoethyl methacrylate, stearethethoxylate allyl ether and pentaerythritol triacrylate, etc.

The actual surface being printed on need not be comprised predominately of the polymer component. Ratios of from 19:1 to 1:19 by weight of polymer to total photo reactable components may be found in the material which comprises the printable surface. Frequently the reactable components, for example a combination of photo initiator and reactable monomer, such as a polyfunctional acrylate, will comprise at least half or more the material comprising the printable surface, the photo initiator alone may comprise half or more of the material. For example, ratios of polymer to photo reactable components of the material comprising the printable surface are commonly from 2:1 to 1:19, or from 1:1 to 1:15, for example the ratio may be, 1:1.5, 1:2, 1:3, 1:4, 1:5, 1:10 etc.

The “reactable components capable of undergoing reaction upon exposure to ultra-violet light, high intensity visible light or electron beam” contained in the printable surface of the invention are also referred to herein as “photo-reactable components”. These include many of the reactable components found in known UV-cured inks, for example, photo initiators, monofunctional monomers, multifunctional monomers, oligomers, polymers and the like.

Photo initiators are not necessarily required to practice the present invention. For example, a photo reaction can occur if the reactants themselves are capable of absorbing the initiating light. However, it is common to incorporate photo initiators into a system which will be photo cured, e.g., UV cured, and typically, photo initiators will be employed as part of the ink or the printable surface of the invention, often, as part of the surface. A variety of photo-initiators are known which initiate a variety of reactions. For example, photo latent acids or bases generate acids or bases upon absorption of light, cations or anions can be formed by photo-initiators and a large number of photo initiators produce reaction initiating radicals upon exposure to light. It is also known to use more than one light absorbing species in a photo-initiator system.

Any of these photo-initiators or photo-initiator systems can be incorporated into the print media comprising the inventive printable surface.

Multifunctional monomers are often used as crosslinking agents which can react with oligomers to build higher molecular weight polymers, or react with polymers to form a more highly crosslinked polymer network. Multifunctional monomers contain at least two reactive groups and often contain more, for example, di-, tri-, tetra-, penta- and hexa-acrylate esters of polyols are known. Other types of multifunctional monomers may also be used.

Any of these monomers, along with reactive oligomers or polymers can be incorporated into the print media as reactive components of the printable surface.

Common oligomers in UV cured inks include, for example, acrylated urethanes, epoxides, polyesters and acrylates. These and/or other oligomers may be used in embodiments of the invention. Typically, many oligomers common in UV cured inks have a molecular weight from about 1,000 to about 30,000. The dividing line between what constitutes an oligomer and what constitutes a polymer is of course not explicit, but the terms are well understood in the art to represent materials incorporating an increasing number of monomer units, polymers being in actuality large oligomers.

For example, acrylated monomers or oligomers, such as epoxy acrylates including those based on Bisphenol A, Novolac, Native oils such as soya oil; aliphatic or aromatic urethane acrylates; polyester acrylates such as those formed from a polyol, polyfunctional organic acid and acrylic acid; acrylated acrylic oligomers and polymers; acrylic acid oligomers and so called “specialty acrylates” including monofunctional acrylates and amine modified acrylates are frequently formulated with photo initiators which induce curing by initiating radical reactions.

For example, photo initiators which induce curing via cationic reactions are frequently formulated with monomers and oligomers comprising epoxides, vinyl ethers, oxetanes and lactones.

These monomers or oligomers and/or photo initiators may be incorporated into the print media as reactive components of the printable surface.

Obviously, when formulating the print media with the printable surface of the present invention, it is necessary to use components compatible not only with each other, but also compatible with the methods by which the printable surface is prepared. For example, all of the reactable components included in the print media must be distributed over the entire area of the printable surface without a large adverse impact the properties of the print media. For example, the fully formulated media must maintain the desired visual characteristics, such as gloss, transparency etc., the desired physical characteristics, such as non-tackiness, good adhesion to the substrate, and the desired print characteristics required to meet the needs of the particular printing application.

Given the widespread use of acrylic monomers in UV curing applications, polymers compatible with such monomers make an excellent choice as print media for the present invention, particularly when the print media is a coating layer applied to a substrate to form a completely transparent surface coating. For example the acrylate or acrylamide polymers of U.S. patent application Ser. No. 10/493,338; 10/499,854; 10/499,855; 10/887,197 and 10/890,449 discussed above which are valuable in the production of multilayered ink jet media such as coated ink jet papers, and coated polyester, polyolefin and vinyl sheets.

Also, the reactable components must not interfere with or become consumed or deactivated by the methods used in processing, drying or curing the print media. For example, the receiving polymers in some media are crosslinked after the media is coated onto a substrate. The reactable components needed in the printable surface must not prevent the crosslinking or become consumed by the crosslinking reactions. In one embodiment of the invention, the reactable components of the printable surface are introduced by applying a formulation comprising the reactable components to the surface of the dried or cured coating and allowing the reactable components to imbibe into the coating surface.

The process of the present invention is readily applied to ink jet printing, for example ink jet printing onto multi layered, coated media, which consists for example of a paper or other support, an ink-receptive layer or ink-absorbing layer or layers, and optionally a protective coating layer. The ink-receptive layer is the ink-receiving or image drying layer. Thin protective coating layers are typically employed to provide physical protection for the underlying layer or to protect the image. Protective layers may reduce tackiness, provide a glossy appearance, and like other layers, offer an ink-receptive surface that may serve as a carrier for specific components of the ink. When such a protective layer is present, the printable surface resides immediately below it.

A barrier layer between a paper support and the ink receptive layer or layers is also typically employed.

Certain polymers or blends of polymers have been employed as components of ink jet recording media and can be used as printing media into which the reactable components of the inventive printable surface are incorporated.

When used herein, the term polymer refers to homopolymers and copolymers. For example, the term polyacrylates refers to homopolymers of a particular acrylate monomer, copolymers comprising different acrylate monomers or copolymers comprising one or more acrylate monomer and one or more non-acrylate monomer wherein the major portion of the polymer comprises one or more acrylate monomers. Major portion means that there is more of that monomer than any other type of monomer.

The print media of the instant invention comprising a polymeric material and containing one or more reactable components capable of undergoing reaction upon exposure to ultra-violet light, high intensity visible light or electron beam is another embodiment of the invention.

That is, printing media comprising a printable surface comprising a polymer and one or more reactable components capable of undergoing reaction upon exposure to ultra-violet light, high intensity visible light or electron beam wherein the reactable components are selected from monomers, oligomers, polymers and photo-polymerization initiators comprising one or more reactable groups selected from ethylenically unsaturated groups, epoxides, hydroxyl, amines, acidic groups, basic groups, latent acids, latent bases and free radical generating groups and wherein each component of the printing media is free of any plasma treatment, corona treatment or flame treatment.

The print media may be a polymeric article prepared from thermoplastic, thermoset, elastomeric, inherently crosslinked or crosslinked polymers into which the reactable components of the inventive printable surface are incorporated or onto which a coating comprising the polymer and photo reactive components of the printable surface are applied. The polymeric article may be a film, fiber, sheet or other molded article.

The thermoplastic, crosslinked or inherently crosslinked polymer is, for example, a polyolefin, polyamide, polyurethane, polyacrylate, polyacrylamide, polyvinyl alcohol, polycarbonate, polystyrene, polyester, polyacetal or a halogenated vinyl polymer such as PVC.

The print media is conveniently prepared by any of the methods described above.

Polymers commonly found in ink jet receiving layers are of particular interest, for example polyacrylates, polyacrylamides, PVP, polyesters, polyurethanes, polyamides, polyvinyl alcohols, for example water soluble or water dispersible polymers such as water soluble or water dispersible polyacrylates, polyacrylamides, PVP, polyurethanes, polyamides, gelatin, hydroxypropyl cellulose and polyvinyl alcohols. Ionic polymers, such as cationic, anionic or zwitterionic polymers are also of particular interest, such as polymeric high molecular weight ammonium salts or cationic or zwitterionic polyacrylates or polyacrylamides. Polymer blends are frequently encountered as print media and may be found in the printable surface of the present invention.

The print media of the present invention may contain all of the components of a photo reactive system, i.e., photo initiator, reactive monomers, reactive oligomers and/or reactive polymers; or the print media may contain a part of the system, for example, the reactive oligomers or the reactive monomers and reactive oligomers, or a reactive polymer and a photo initiator etc, and the remaining components of the reactable system may be introduced as part of the ink formulation. Any number of variations can be contemplated.

The composition of the final, cured image obtained from the present method may also in many ways resemble the composition of a cured image created by applying a UV curable ink to a known printable surface and then curing the ink, but again, the greater flexibility in ink formulation allows for an image with greater sharpness and resolution.

That is, the instant invention can provide in many instances the durability benefits associated with UV cured inks, such as good adhesion, mar resistance, scratch resistance and/or good water fastness etc, while overcoming many of the shortcomings of using UV cured inks to provide images of good print quality.

### EXAMPLES

As elsewhere in this disclosure, “parts” refer to parts by weight.

Using conventional free radical polymerization techniques and following the procedures of US 2002/0127376 the following combination of monomers are polymerized in water; 45 parts methyl methacrylate, 49.5 parts dimethylaminoethyl methacrylate, 5 parts steareth (10 mole) ethoxylate allyl ether and 0.50 parts pentaerythritol triacrylate; yielding a polymer dispersion in water, 15% polymer content in water, to which is added acetic acid to reduce the pH to 4.0.

The above neutralized polymer/water mixture is used to prepare the following formulations

| Formulation | Water | Polymer | SR 344 | PI | Surfactant |
|---|---|---|---|---|---|
| Example 1 | 0.00 | 34.50* | 0.0 | 60.70 | 4.80 |
| Example 2 | 0.00 | 17.25* | 17.25 | 60.70 | 4.80 |
| Example 3 | 0.00 | 25.87* | 8.63 | 60.70 | 4.80 |
| Example 4 | 0.00 | 8.63* | 25.87 | 60.70 | 4.80 |
| Example 5 | 25.87** | 8.63* | 0.0 | 60.70 | 4.80 |

Wherein
The numbers refer to parts by weight,
*weight of polymer solids in the above polymer dispersion in water
**additional water added to the dispersion
SR 344 is SARTOMER SR 344, a commercial polyethylene glycol diacrylate
PI is the photo initiator tridecylethyleneglycol-bis-phenylglyoxalate
Surfactant is UNIQEMA ZEPHRYM 3300B a commercial alkylaryl sulphonate surfactant

The formulations are applied by Meyer bar to biaxially orientated polyester (PET) and low density polyethylene films (LDPE) and dried in a convection oven at 60° C. to remove the water and acetic acid, resulting in a dry film between 3-5 μm thick on each of the two substrates. The samples are then printed on with UV curable inks and tested for ink adhesion.

### UV Curable Cyan Ink

The dried coatings are printed on using commercial techniques with a UV curable cyan packaging ink and the ink and coating compositions are UV cured under a medium pressure mercury bulb at a power of 200 W/cm and a conveyor speed of 40 m/min. Uncoated PET and LDPE samples are also printed on as blanks.

The ink is tested for adhesion to the coating by firmly adhering tape to the ink and either immediately removing the tape (t0) or removing the tape after 1 minute (t1). Visual examination is used to approximate the ink removed. Results are shown in the table below.

| | |
|---|---|
| LDPE | PET |

| Formulation | t0 | t1 | t0 | t1 |
|---|---|---|---|---|
| Example 1 | 0 | 0 | 0 | 1 |
| Example 2 | 0 | 0 | 0 | 1 |
| Example 3 | 0 | 0 | 0 | 1 |
| Example 4 | 0 | 1 | 1 | 1 |
| Example 5 | 0 | 1 | 1 | 1 |
| Blank | 4 | 5 | 4 | 5 |
| (No coating) | | | | |

0 = 0% removal of the ink
1 = >5% removal of the ink
2 = 5-10% removal of the ink
3 = 10-20% removal of the ink
4 = 20-50% removal of the ink
5 = 50-100% removal of the ink

The adhesion of the UV curable ink is improved when applied to the UV curable coating.

### UV Curable Magenta Flexo Ink

Magenta ink commercially used to print flexible packaging substrates by flexographic printing methods are evaluated using the procedures above. The results are shown below.

| | | |
|---|---|---|
| Formulation | LDPE | PET |

| code | t0 | t1 | t0 | t1 |
|---|---|---|---|---|
| Pb 1 | 0 | 0 | 4 | 5 |
| Pb 2 | 0 | 0 | 0 | 1 |
| Pb 3 | 0 | 1 | 0 | 2 |
| Pb 4 | 0 | 0 | 0 | 3 |
| Pb 5 | 0 | 0 | 0 | 1 |
| No coating | 4 | 5 | 4 | 5 |

### UV Curable Cyan Flexo Ink

Cyan ink commercially used to print flexible packaging substrates by flexographic printing methods are evaluated using the procedures above. The results are shown below.

| | | |
|---|---|---|
| Formulation | LDPE | PET |

| code | t0 | t1 | t0 | t1 |
|---|---|---|---|---|
| Pb 1 | 0 | 1 | 0 | 1 |
| Pb 2 | 0 | 0 | 0 | 0 |
| Pb 3 | 0 | 1 | 2 | 4 |
| Pb 4 | 0 | 1 | 3 | 3/4 |
| Pb 5 | 0 | 1 | 3 | 4 |
| No coating | 4 | 5 | 4 | 5 |

The adhesion of flexo ink is improved when applied to the UV curable coating.

1. A method of producing a printed image which method comprises
a) preparing a printable surface comprising a polymer and one or more reactable components capable of undergoing reaction upon exposure to ultra-violet light, high intensity visible light or electron beam
wherein the reactable components are selected from monomers, oligomers, polymers and photo-polymerization initiators comprising one or more reactable groups selected from ethylenically unsaturated groups, epoxides, hydroxyl, amines, acidic groups, basic groups, latent acids, latent bases and free radical generating groups
b) applying an ink to said surface and then
c) exposing the surface with applied ink to ultra-violet light, high intensity visible light or electron beam to initiate reaction of the one or more reactable components of the surface,
which process excludes plasma treatment, corona treatment or flame treatment, prior to exposing the surface with applied ink to ultra-violet light, high intensity visible light or electron beam radiation, of any component comprised by an article which comprises the printed image.

2. A method according to claim 1, wherein the ratio of polymer to total photo reactable components in a) is from 19:1 to 1:19 by weight.

3. A method according to claim 1, wherein the ratio of polymer to total photo reactable components in a) is from 2:1 to 1:19 by weight.

4. A method according to claim 1, wherein the ethylenically unsaturated groups are selected from vinyl, vinyl ether, allyl, methacrylate, acrylate, methacrylamide and acrylamide groups.

5. A method according to claim 1, wherein the printable surface contains a photo initiator.

6. A method according to claim 1, wherein the ink is applied in an ink jet printing process.

7. A method according to claim 1, wherein the printable surface is the surface of an ink receiving layer of a multi-layered article.

8. A method according to claim 7, wherein the ink receiving layer comprises a cationic, anionic or zwitterionic polymer selected from polyacrylate, polyacrylamide, PVP, polyester, polyurethane, polyamide and polyvinyl alcohol polymers.

9. A method according to claim 7, wherein the ink receiving layer is prepared by
preparing a coating formulation comprising the polymer or polymers and the reactable components of the printable surface
applying the coating formulation to a substrate and drying the coating formulation prior to ink application.

10. A method according to claim 9, wherein the coating formulation which is applied to the substrate is an aqueous coating formulation.

11. A method according to claim 10, wherein the aqueous coating formulation is an aqueous suspension or solution which suspension or solution comprises a cationic, anionic or zwitterionic polymer selected from polyacrylate, polyacrylamide, PVP, polyester, polyurethane, polyamide and polyvinyl alcohol polymers.

12. A method according to claim 7, wherein the printable surface is prepared by applying a coating containing a cationic polyacrylate polymer to a PET or polyolefin substrate.

13. A method according to claim 1, wherein the ink contains one or more reactable components capable of undergoing reaction upon exposure to ultra-violet light, high intensity visible light or electron beam radiation wherein the reactable components are selected from monomers, oligomers, polymers and photo-polymerization initiators comprising one or more reactable groups selected from ethylenically unsaturated groups, epoxides, hydroxyl, amines, acidic groups, basic groups, latent acids, latent bases and free radical generating groups.

14. A printing medium comprising a printable surface comprising a polymer and one or more reactable components capable of undergoing reaction upon exposure to ultra-violet light, high intensity visible light or electron beam
wherein the reactable components are selected from monomers, oligomers, polymers and photo-polymerization initiators comprising one or more reactable groups selected from ethylenically unsaturated groups, epoxides, hydroxyl, amines, acidic groups, basic groups, latent acids, latent bases and free radical generating groups
and wherein each component of the printing media is free of any plasma treatment, corona treatment or flame treatment.

15. A printing medium according to claim 14, wherein the ratio of polymer to total photo reactable components in the printable surface is from 19:1 to 1:19 by weight.

16. A printing medium according to claim 15, wherein the ratio of polymer to total photo reactable components in the printable surface is from 2:1 to 1:19 by weight.

17. A printing medium according to claim 15, wherein the ethylenically unsaturated groups are selected from such as vinyl, vinyl ether, allyl, methacrylate, acrylate, methacrylamide and acrylamide groups.

18. A printing medium according to claim 15 which is an ink jet printing media.

19. A printing medium according to claim 15, wherein the printable surface comprises a cationic, anionic or zwitterionic polymer selected from polyacrylate, polyacrylamide, PVP, polyester, polyurethane, polyamide and polyvinyl alcohol polymers a polyacrylate, polyacrylamide, PVP, polyester, polyurethane, polyamide or polyvinyl alcohol.

20. A printing medium according to claim 15 which is a polymeric article prepared from a thermoplastic, thermoset, elastomeric, inherently crosslinked or crosslinked polymer onto which a coating comprising the polymer and photo reactive components of the printable surface are applied.
